(19) United States
(12) Patent Application Publication
(10) Pub. No.: US 2006/0202060 A1
(43) Pub. Date: Sep. 14, 2006

(54) Dispensing device handle assembly

(76) Inventor: Kevin L. Alexander, Brownsburg, IN (US)

Correspondence Address: BARNES & THORNBURG, 11 SOUTH MERIDIAN, INDIANAPOLIS, IN, 46204, US

(21) Appl. No.: 11/005,602

(22) Filed: Dec. 6, 2004

(51) Int. Cl. B05B 9/01

(52) U.S. Cl. 239/525; 239/290; 239/296; 239/526

(57) ABSTRACT

A hand tool includes at least a handle and an adjustable finger shelf, or a handle and a trigger. If a handle and adjustable finger shelf, one of the handle and adjustable finger shelf includes a first engagement portion, and the other of the handle and adjustable finger shelf includes a second engagement portion for movably engaging the first engagement portion to permit relative movement between the first and second engagement portions. A device is provided for fixing the first and second engagement portions in an adjusted orientation. If the hand tool includes a handle and trigger, one of the trigger and handle includes bosses and the other of the trigger and handle includes openings for receiving the bosses to mount the trigger movably from the handle.

### FIELD OF THE INVENTION

This invention relates to the configurations of handles for hand-held tools. It is disclosed in the context of handles for coating dispensing equipment (hereinafter sometimes spray guns). However, it is believed to be useful in other applications as well.

### BACKGROUND OF THE INVENTION

A great number of configurations for the handles of hand-held tools are known. Among configurations of interest are the configurations illustrated and described in the following listed U.S. Patents and published applications: 2003/0006322; U.S. Pat. Nos. 6,712,292; 6,698,670; 6,669,112; 6,572,029; 6,460,787; 6,402,058; RE36,378; U.S. Pat. Nos. 6,276,616; 6,189,809; 6,179,223; 5,836,517; 5,829,679; 5,803,313; RE-35,769; U.S. Pat. Nos. 5,639,027; 5,618,001; 5,582,350; 5,553,788; 5,400,971; 5,395,054; D349,559; U.S. Pat. Nos. 5,351,887; 5,332,159; 5,332,156; 5,330,108; 5,303,865; 5,299,740; 5,289,974; 5,284,301; 5,284,299; 5,236,129; 5,209,405; 5,209,365; 5,178,330; 5,119,992; 5,118,080; 5,180,104; D325,241; U.S. Pat. Nos. 5,090,623; 5,074,466; 5,064,119; 5,054,687; D318,712; U.S. Pat. Nos. 5,022,590; 4,993,645; 4,934,607; 4,934,603; 4,927,079; 4,911,367; D305,453; D305,452; D305,057; D303,139; U.S. Pat. Nos. 4,844,342; 4,770,117; 4,760,962; 4,759,502; 4,747,546; 4,702,420; 4,613,082; 4,606,501; D287,266; U.S. Pat. Nos. 4,537,357; 4,529,131; 4,513,913; 4,483,483; 4,453,670; 4,437,614; 4,433,812; 4,401,268; 4,361,283; D270,368; D270,367; D270,180; D270,179; RE30,968; U.S. Pat. Nos. 4,331,298; 4,248,386; 4,214,709; 4,174,071; 4,174,070; 4,169,545; 4,165,022; D252,097; U.S. Pat. Nos. 4,133,483; 4,116,364; 4,114,564; 4,105,164; 4,081,904; 4,037,561; 4,030,857; 4,002,777; 4,001,935; 3,990,609; 3,964,683; and, 3,940,061. The disclosures of these references are hereby incorporated herein by reference. This listing is not intended to be a representation that a complete search of all relevant art has been made, or that no more pertinent art than that listed exists, or that the listed art is material to patentability. Nor should any such representation be inferred.

### DISCLOSURE OF THE INVENTION

According to an aspect of the invention, a handle and an adjustable finger shelf are provided for a hand tool. One of the handle and adjustable finger shelf includes a first engagement portion. The other of the handle and adjustable finger shelf includes a second engagement portion for movably engaging the first engagement portion to permit relative movement between the first and second engagement portions. A device is provided for fixing the first and second engagement portions in an adjusted orientation.

Illustratively, the first engagement portion comprises a track or rail provided on one of handle and adjustable finger shelf. The second engagement portion comprises a complementarily configured groove provided on the other of handle and adjustable finger shelf

Further illustratively, the first engagement portion comprises a track or rail provided on handle. The second engagement portion comprises a complementarily configured groove provided on the adjustable finger shelf.

Additionally illustratively, the handle comprises a first surface and the adjustable finger shelf comprises a generally complementarily configured second surface.

Further illustratively, the first surface of the handle lies generally behind the trigger.

Illustratively, the first engagement portion comprises a track or rail provided on the first surface. The second engagement portion comprises a complementarily configured groove provided on the second surface.

According to another aspect of the invention, a handle and trigger are provided for a hand tool. One of the trigger and handle includes bosses and the other of the trigger and handle includes openings for receiving the bosses to mount the trigger movably from the handle.

Illustratively, the trigger includes bosses provided on the trigger. The handle includes openings on the handle for receiving the bosses to mount the trigger movably from the handle.

Further illustratively, the trigger includes a yoke providing ears having facing surfaces. The bosses are formed on the facing surfaces and project toward one another.

Additionally illustratively, the yoke is formed from resiliently deformable material permitting the ears to be spread apart. The bosses engage in the complementarily configured openings in the handle upon release, owing to the resiliency of the material from which the yoke is constructed.

Illustratively, the handle, adjustable finger shelf and trigger are provided on a coating material dispensing device.

### BRIEF DESCRIPTION OF THE DRAWINGS

The invention may best be understood by referring to the following detailed description and accompanying drawings which illustrate the invention. In the drawings:

FIGS. 1a-b illustrate a fragmentary, partly sectional side elevational view of a spray gun incorporating the present invention;

FIG. 2 illustrates a fragmentary, partly sectional side elevational view of another spray gun handle assembly incorporating the present invention;

FIG. 3 illustrates a fragmentary sectional front elevational view of a trigger for use on the handle of FIG. 2;

FIG. 4 illustrates a greatly enlarged, fragmentary sectional view of the handle of either FIGS. 1a-b or FIG. 2, taken generally along section lines 4-4 thereof; and,

FIGS. 5a-e illustrate several enlarged views of a detail of the handle of either FIGS. 1a-b or FIG. 2, with FIG. 5a illustrating a front elevational view, FIG. 5b a right side elevational view, FIG. 5c a top plan view, FIG. 5d a bottom plan view and FIG. 5e an enlarged view of a detail of FIG. 5c.

### DETAILED DESCRIPTIONS OF ILLUSTRATIVE EMBODIMENTS

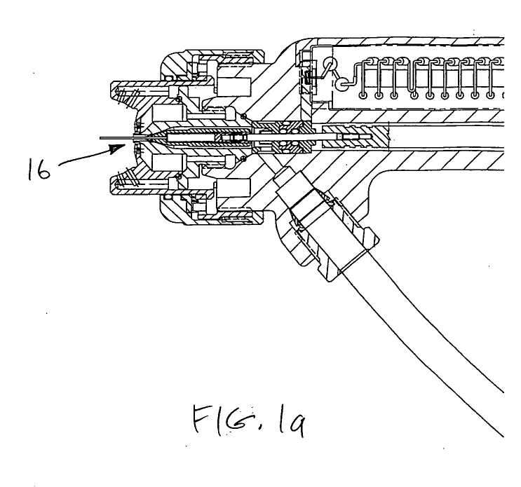

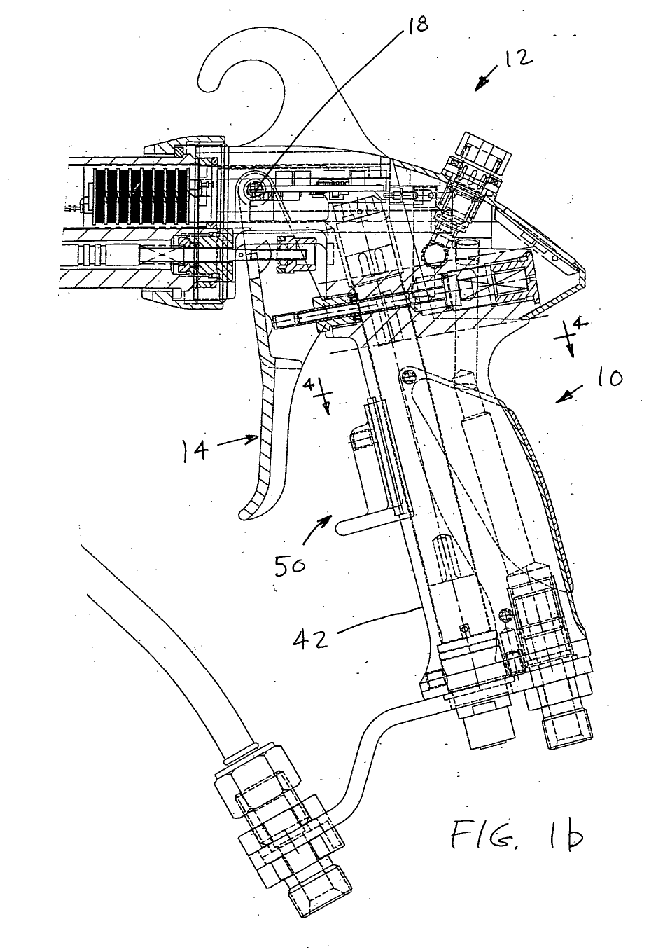

Referring now to FIGS. 1a-b, a handle 10 of a spray gun 12 is molded from a suitable moldable and/or machinable, filled or unfilled resin or polymer. It may be, and in some cases will be, preferred that the material from which the handle 10 is constructed be electrically non-insulative. This may militate in favor of using certain electrically non-insulative resin or polymer materials and/or in favor of filling the resin or polymer with electrically non-insulative filler such as, for example, carbon. The handle 10 includes a trigger 14, operation of which by the operator operates a valve 16 to permit the flow of a coating material forward in the spray gun 12 toward a nozzle (not shown) from which the coating material is atomized and dispensed, typically, but not necessarily, with the aid of a compressed gas flow and/or electrostatic charging of the particles of coating material as they are atomized and dispensed.

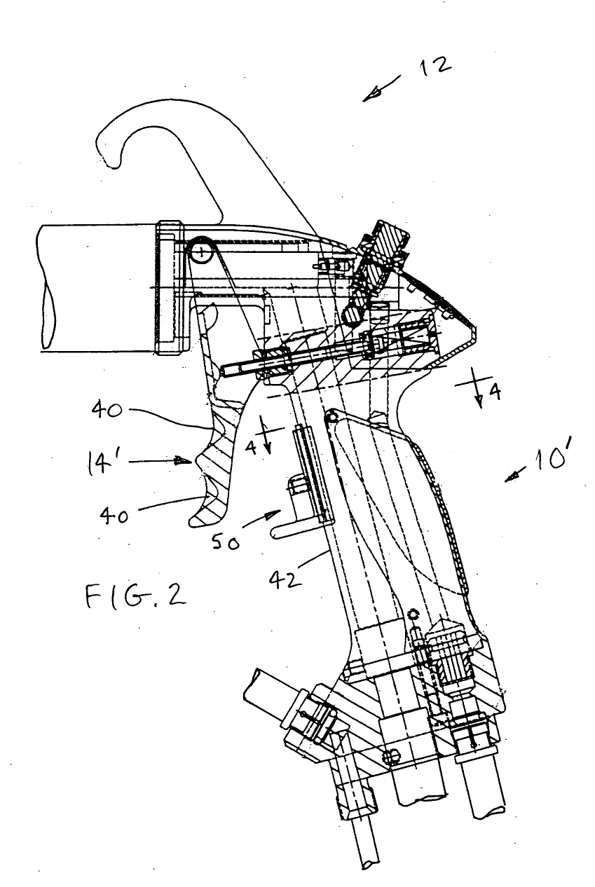

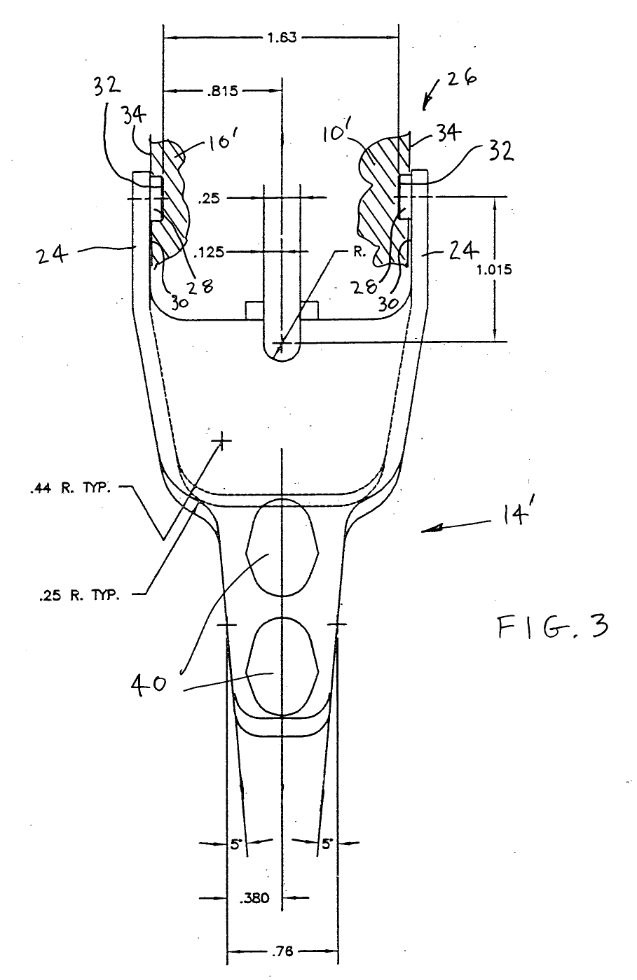

In the embodiment illustrated in FIGS. 1a-b, the trigger 14 is mounted to the handle 10 by two coaxial threaded fasteners 18, illustratively 316 stainless steel, #10-32 thread, slotted pan head screws. In the embodiment of the handle 10′ illustrated in FIG. 2, and with a trigger 14′ of the type illustrated in FIG. 3, the ears 24 of the trigger 14′ yoke 26 are provided with coaxial, right circular cylindrical bosses 28 which project toward each other from the inside surfaces 30 of the ears 24. Complementarily configured wells 32 are provided on the sides 34 of the handle 10′ to pivotally receive the bosses 28, pivotally mounting the trigger 14′ on the handle 10′. While the illustrated triggers 14, 14′ are two finger length triggers with and without finger reliefs 40, it is clear that longer triggers can be molded, machined or otherwise formed for three- or four finger use.

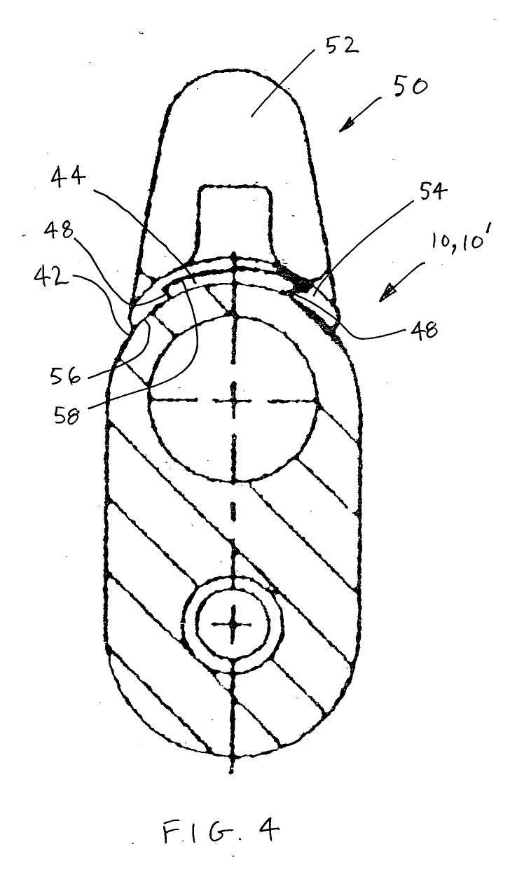

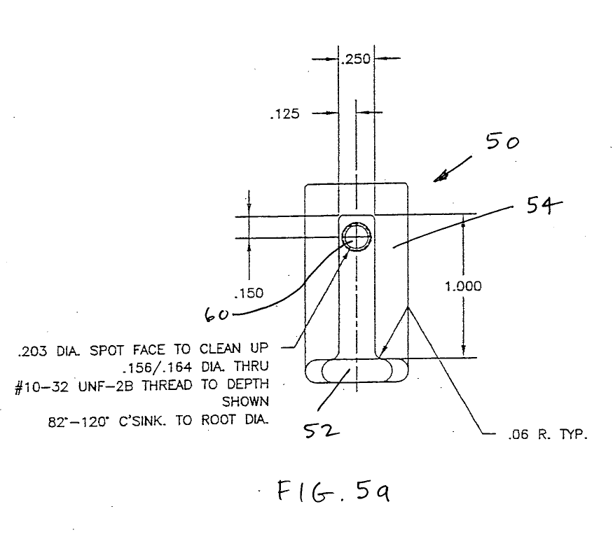

Referring particularly to FIG. 4, the front surface 42 of each handle 10, 10′, in the area generally behind the trigger 14, 14′, is provided with a boss 44 in the form of a track or rail. The curvature of the front surface 42 of the handle 10, 10′ behind the trigger 14, 14′ is generally a sector of a right circular cylinder, and so the track or rail 44 is generally the configuration of a sector of a sidewall of a right circular cylindrical tube or pipe lying against the front surface 42 of the handle 10, 10′, with the sidewalls 48 of the track or rail 44 lying generally on radii of the tube so that the sidewalls 48 diverge from each other.

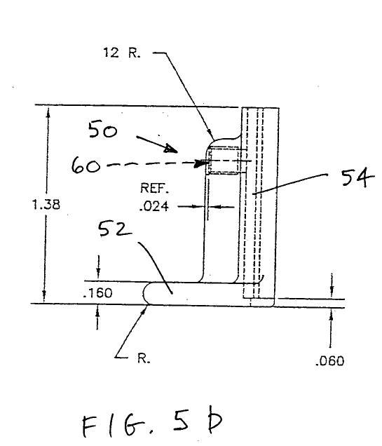

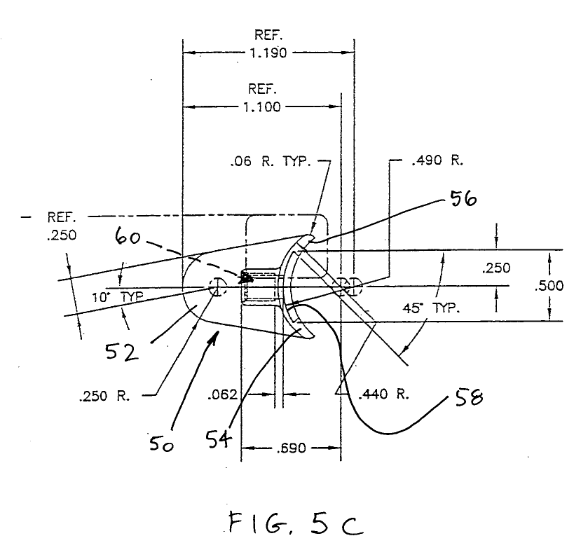

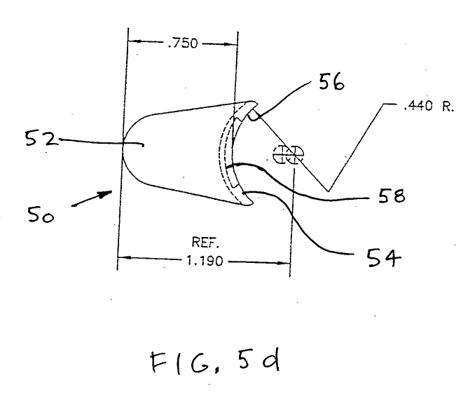

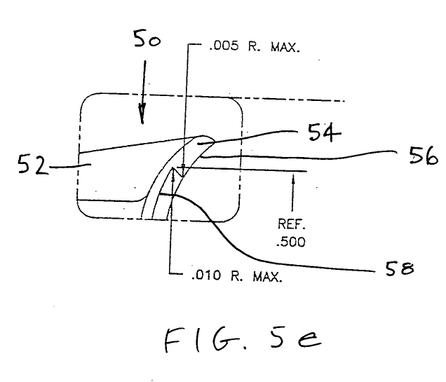

Referring to FIGS. 4 and 5a-e, the adjustable finger shelf 50 includes a finger rest portion 52, or ledge, and a slide portion 54. The slide portion 54 includes a back surface 56 generally complementarily configured to the front surface 42 of handle 10, 10′ behind trigger 14, 14′. The back surface 56 includes a groove 58 complementarily configured to track or rail 44. Adjustable finger shelf 50 can be slid onto track or rail 44 from the bottom of track or rail 44 by engaging the track or rail 44 in groove 58 and adjusting the finger shelf 50 to the desired position on handle 10, 10′. A set screw 60 with which adjustable finger shelf 50 is provided is then screwed inward into a threaded hole provided in adjustable finger shelf 50 against the boss 44 in the form of a track or rail on the front surface 42 of handle 10, 10′ to fix the adjustable finger shelf 50 in position on handle 10, 10′.

The invention thus provides an adjustable finger shelf 50 for spray guns 12 or the like. The operator sometimes prefers a different trigger 14, 14′ length other than the length with which a spray gun 12 is equipped, for example, a two-, three- or four finger trigger 14, 14′ length. A finger shelf 50 is generally provided to help balance the spray gun 12 in the operator's hand. For a two finger length trigger 14, 14′, the shelf 50 may be adjusted to lie between the second and third fingers or between the third and fourth fingers of the operator. For a three finger length trigger 14, 14′, the shelf 50 may be adjusted to lie between the third and fourth fingers of the operator. For a four finger trigger 14, 14′, the shelf 50 may be removed. To render the shelf 50 adjustable, one or the other of the shelf 50 and handle 10, 10′ includes a first feature 44, 58, for example, a track 44 or groove 58 formed on its surface 42, 56 facing the other of the shelf 50 and handle 10, 10′. The track 44 or groove 58 extends in the direction of adjustment of the shelf 50, generally along the length of the handle 10, 10′. A complementary second feature 58, 44, for example, a groove 58 or track 44, is formed in the other of the shelf 50 and handle 14, 14′. The shelf 50 slides on the track 44 or in the groove 58 to an adjusted position and a set screw 60 is tightened to fix the shelf 50 in the adjusted position.

The adjustable finger shelf 50 permits the operator to change trigger 14, 14′ configurations among, for example, two-, three- and four finger triggers 14, 14′. The adjustable finger shelf 50 reduces the number of different styles of handles 10, 10′ that must be maintained, since the adjustable finger shelf 50 can be adjusted to clear any one of the two-, three- or four finger triggers 14, 14′. It also permits the operator to make small adjustments in finger shelf 50 position that make considerable differences in operator comfort and fatigue, two significant concerns in spray gun 12 use.

The spray gun handle 10, 10′ and adjustable finger shelf 50 illustratively are constructed from the same moldable, machinable, abrasion-resistant, electrically non-insulative material, such as, for example, carbon fiber filled Nylon 12 polyamide.

The invention further provides a trigger 14′ that can be attached to the handle 10′ of a spray gun 12 with little or no use of tools. The trigger 14′ is constructed from the same electrically non-insulative material as the spray gun handle 10′. This enhances grounding of the operator when the spray gun handle 10′ is grounded, which is important to minimize the likelihood of, for example, shock in electrostatically aided atomization and dispensing applications, when certain components of the spray gun 12 are maintained at relatively high-magnitude electrostatic potentials. The trigger 14′ includes bosses 28 formed, for example, molded, opposite each other inside the yoke 26 or ears 24 of the trigger 14′. The construction and materials permit the ears 24 to be spread slightly for mounting the trigger 14′ to the spray gun 12. The bosses 28 snap into complementarily configured wells 32 provided therefor on the sides of the spray gun handle 10′, owing to the resiliency of the material from which the trigger 14′ is constructed. This promotes simple installation and removal of the trigger 14′, and convenient conversion to, for example, a two-, three- or four-finger trigger 14′, according to the operator's preference. It also reduces the amount of hardware, for example, threaded fasteners, which is required to be manipulated and retained during the removal and replacement of a trigger 14 on the spray gun 12. Whenever such hardware is removed to replace a trigger 14, there is a risk that the hardware will be lost before the replacement trigger 14 is installed on the spray gun 12. Also, elimination of such hardware eliminates any maintenance, such as periodic tightening, of such hardware.

What is claimed is:

1. A handle and an adjustable finger shelf for a hand tool, one of the handle and adjustable finger shelf including a first engagement portion, and the other of the handle and adjustable finger shelf including a second engagement portion for movably engaging the first engagement portion to permit relative movement between the first and second engagement portions, and a device for fixing the first and second engagement portions in an adjusted orientation.

2. The handle and adjustable finger shelf of claim 1 for a coating material dispensing device.

3. The handle and adjustable finger shelf of claim 1 wherein the first engagement portion comprises a track or rail provided on one of handle and adjustable finger shelf, and the second engagement portion comprises a complementarily configured groove provided on the other of handle and adjustable finger shelf.

4. The handle and adjustable finger shelf of claim 3 for a coating material dispensing device.

5. The handle and adjustable finger shelf of claim 3 wherein the first engagement portion comprises a track or rail provided on handle, and the second engagement portion comprises a complementarily configured groove provided on the adjustable finger shelf.

6. The handle and adjustable finger shelf of claim 5 for a coating material dispensing device.

7. The handle and adjustable finger shelf of claim 1 wherein the handle comprises a first surface and the adjustable finger shelf comprises a generally complementarily configured second surface.

8. The handle and adjustable finger shelf of claim 7 for a coating material dispensing device.

9. The handle and adjustable finger shelf of claim 7 further including a trigger, wherein the first surface of the handle lies generally behind the trigger.

10. The handle and adjustable finger shelf of claim 9 for a coating material dispensing device.

11. The handle and adjustable finger shelf of claim 9 wherein the first engagement portion comprises a track or rail provided on the first surface, and the second engagement portion comprises a complementarily configured groove provided on the second surface.

12. The handle and adjustable finger shelf of claim 9 wherein one of the trigger and handle includes bosses and the other of the trigger and handle includes openings for receiving the bosses to mount the trigger movably from the handle.

13. The handle and adjustable finger shelf of claim 12 for a coating material dispensing device.

14. The handle and adjustable finger shelf of claim 12 wherein the trigger includes bosses provided on the trigger and the handle includes openings on the handle for receiving the bosses to mount the trigger movably from the handle.

15. The handle and adjustable finger shelf of claim 14 for a coating material dispensing device.

16. The handle and adjustable finger shelf of claim 14 wherein the trigger includes a yoke providing ears having facing surfaces, the bosses formed on the facing surfaces and projecting toward one another.

17. The handle and adjustable finger shelf of claim 16 for a coating material dispensing device.

18. The handle and adjustable finger shelf of claim 16 wherein the yoke is formed from resiliently deformable material permitting the ears to be spread apart, the bosses movably engaging in the complementarily configured openings in the handle.

19. A handle and trigger for a hand tool, one of the trigger and handle including bosses and the other of the trigger and handle including openings for receiving the bosses to mount the trigger movably from the handle.

20. The handle and trigger of claim 19 for a coating material dispensing device.

21. The handle and trigger of claim 19 wherein the trigger includes bosses provided on the trigger and the handle includes openings on the handle for receiving the bosses to mount the trigger movably from the handle.

22. The handle and trigger of claim 21 for a coating material dispensing device.

23. The handle and trigger of claim 21 wherein the trigger includes a yoke providing ears having facing surfaces, the bosses formed on the facing surfaces and projecting toward one another.

24. The handle and trigger of claim 23 for a coating material dispensing device.

25. The handle and trigger of claim 23 wherein the yoke is formed from resiliently deformable material permitting the ears to be spread apart, the bosses engaging in the complementarily configured openings in the handle.

26. The handle and trigger of claim 25 for a coating material dispensing device.
